(19) United States
(12) Patent Application Publication
(10) Pub. No.: US 2009/0103301 A1
(43) Pub. Date: Apr. 23, 2009

(54) Illuminated stationary vehicle with simulated moving parts

(76) Inventor: Chin Chen Chang, Hsin Chu (TW)

Correspondence Address: James W. Badie, Esq., 521 Fifth Avenue, Suite 3300, New York, NY, 10175-3399, US

(21) Appl. No.: 11/975,562

(22) Filed: Oct. 22, 2007

(51) Int. Cl. F21V 21/00; F21S 13/14

(52) U.S. Cl. 362/249.16

(57) ABSTRACT

A two-wheel vehicle is provided which is secured in stationary position but wherein the front and the rear wheels of the vehicles are provided with a string of lights which twinkle annularly and thus impart the appearance that the wheels are rotating and the vehicle is in motion while in stationary mode.

### FIELD OF THE INVENTION

This invention relates generally to light-decorated vehicles and, in one aspect, the invention is related to stationary vehicles, as art objects, which when illuminated in accordance with the present invention impart the appearance of motion to the stationary vehicles.

### BACKGROUND OF THE INVENTION

Decorative illuminated objects and products are in widely used in various settings, particularly in the dark hours. Whether illuminated or not the objects appear stationary and normally remain in the stationary state while illuminated.

Various decorative illuminated products are disclosed and described in several patents. These patents describe various illuminated objects in art form for their aesthetic appearances. For example, Publication No. US 2006/0078270 A1, published Apr. 13, 2006 shows a lighted figurine comprising a polyurethane casing with multiple holes drilled in the casing for installing the illuminants.

U.S. Pat. No. 5,534,315 issued to Donald H. White on Jul. 9, 1996 discloses various illuminated decorative art forms, including illuminated Santa Claus.

U.S. Pat. No. 7,086,770 B2 issued to Robert Tell on Aug. 8, 2006 discloses a method and an apparatus for producing an illuminated animated effect.

Publication No. US 2002/0112385 A1, published Aug. 22, 2002 describes structure of a Christmas decoration comprising separate ramified illuminated bodies.

As it can be appreciated from the disclosures of the aforementioned patents, none of them relate to or disclose stationary vehicles which, due to special illumination arrangement associated with the vehicle, impart the appearance that the vehicle is in motion while in fact it is fixed in position.

It is therefore an object of the present invention to provide illuminated stationary vehicles having simulated moving parts.

It is a further object of the invention to provide illuminated stationary vehicles which, due to special arrangements and operation of the illuminants associated therewith, projects the appearance that the vehicle is in motion even though it is in fixed and secured position.

The foregoing and other objects of the present invention will be appreciated from the ensuing description and the drawings which form part of this application.

### SUMMARY OF THE INVENTION

This invention provides a two-wheel vehicle such as a motorcycle comprising a motorcycle chassis of known variety having a front wheel and a rear wheel, and a seat for a rider. A handle is coupled to the wheel and a rider grips the handle with the rider's feet resting on a pedal while the motorcycle is secured in position. The rider in the present invention is a figurine depicted in the likeness of Santa Claus, but may be any other type of figurine. The figurine is illuminated by a set of lights consisting of a plurality of light bulbs, in series, which highlight the shape of the figurine. The wheels are provide with a light string consisting of a plurality of interconnected light bulbs which when energized twinkle in an annular fashion thereby imparting the appearance that the wheels are rotating and the motorcycle is a motion while in fact is stationery position.

### DETAILED DESCRIPTION OF THE DRAWINGS

In the drawings, wherein like reference numerals designate like parts:

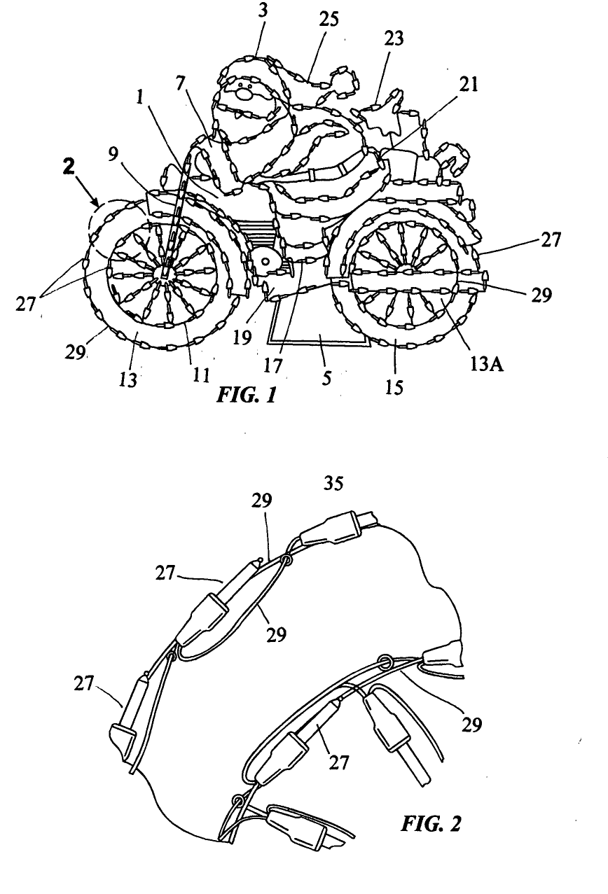

FIG. 1 is a side, partly perspective view of a vehicle in the form of a motorcycle with a rider conveniently depicted as the likeness of Santa Claus;

FIG. 2 is a schematic diagram of the illuminants and their associated wiring of a segment 2 in FIG. 1 of the illumination used to light up the vehicle; and

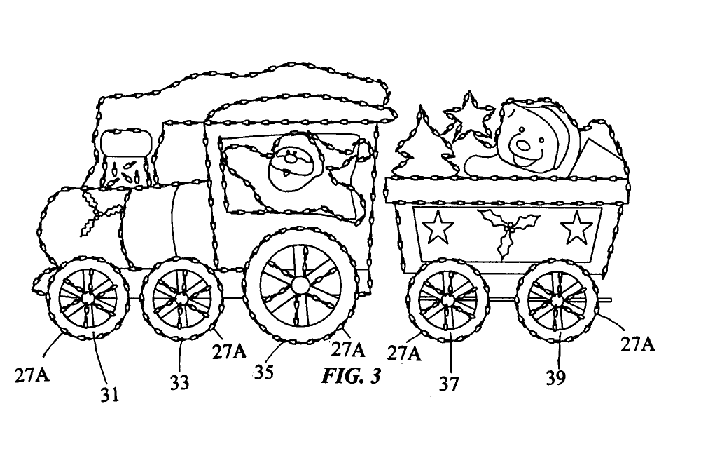

FIG. 3 is a side view of another vehicle, such as a choo choo train with attached wagons, illuminated in accordance with this invention to simulate a moving vehicle while in stationary mode.

### DETAILED DESCRIPTION OF THE INVENTION

Referring first to FIG. 1, there is shown a motorcycle generally designated as 1 with a rider 3 which may be a figurine but herein depicted in the likeness of Santa Claus. The motorcycle is supported on the ground by the bracket 5 which secures the motorcycle in fixed position. The hands 7 of the figurine 3 maneuver the handle 9 which is fixed to the hub 11 of the front wheel 13 of the 2-wheel motorcycle having the front wheel 13 and the back wheel 15 having the hub 13A. The foot 17 of the figurine 3 is shown resting on a pedal 19 simulating a motorcycle rider in use.

The motorcycle shown in FIG. 1 is provided with illumination by two sets of separate strings of lights (illuminants); a fixed string of lights 21 comprising a plurality of light bulbs 23 with associated strings or wiring 25 to illuminate the figurine 3, and a second string of lights 27 with associated strings or wiring 29 operatively associated with the motorcycle wheels 13 and 15 as shown in FIG. 1.

The light bulbs 23 and 27 may be energized by external connection to an electric terminal (not shown) or energized by battery (not shown). The source of electrical connectors of the light bulbs are not per se critical in the present invention. When the light bulbs 23 and 27 are energized, the light bulbs 23 illuminate the figurine without imparting the appearance of motion to the figurine. However, when the light bulbs 27 are energized, they twinkle in an annular fashion, one after the other, thus imparting the visual appearance that the wheels 13 and 15 are rotating thereby simulating movement of the motorcycle even though, in fact, it is in stationary position.

The arrangement of the bulbs 27 and their associated strings or wiring 29 is shown in FIG. 2 which is an enlarged view of a section, such as Section 2 of FIG. 1.

In FIG. 3, the simulated motion of the choo choo train is achieved in the same manner as in FIG. 1, i.e., by securing a string of light bulbs to the wheels 31, 33, 35, 37 and 39 of the train caboose and the wagon. Movements of the wheels are simulated by the annular twinkling of the light bulbs 27A much in the same manner as in the case of the motorcycle in FIG. 1.

Even though the vehicles shown in FIG. 3 are four-wheel vehicles, for the purpose of this invention, only the side view of the vehicle is of significance. When viewed from the side the two wheels are provided with the type of illumination described in connection with FIG. 1 and impart the appearance of motion to the wheels while the vehicle is in stationary mode.

1. A two-wheel vehicle comprising a chassis having a front wheel and a rear wheel, a seat for riding said vehicle, a handle coupled to said front wheel, a rider in the general form of a figurine riding on said seat, said rider having hands for gripping said handle and feet resting on a pedal of said vehicle, a first set of light strings decoratively associated with said figurine, said first set of light strings comprising a plurality of spaced apart light bulbs which illuminate said figurine, and a second set of light strings comprising a plurality of light bulbs associated with said front wheel and said rear wheel, said light bulbs of said second light string when illuminated, twinkle annularly thereby imparting the appearance of rotation to said front wheel and said rear wheel while the vehicle is in fixed position.
